(19) United States
(12) Patent Application Publication
(10) Pub. No.: US 2016/0187527 A1
(43) Pub. Date: Jun. 30, 2016

(54) COLLOCATED RADIATION SENSING

(71) Applicant: SCHLUMBERGER TECHNOLOGY CORPORATION, Sugar Land, TX (US)

(72) Inventor: Markus Berheide, Cambridge, MA (US)

(21) Appl. No.: 14/974,044

(22) Filed: Dec. 18, 2015

Related U.S. Application Data
(60) Provisional application No. 62/098,325, filed on Dec. 30, 2014.

(51) Int. Cl. G01V 5/08

(52) U.S. Cl. CPC G01V 5/08

(57) ABSTRACT

Collocated radiation sensing is provided. In one possible implementation, a tool to be placed in a wellbore includes a first source of nuclear radiation and a second source of nuclear radiation. The tool also includes one or more sensors configured to discriminate between radiation emitted by the first and second sources and correctly attribute the radiation to the source from which the radiation was emitted. The one or more sensors are collocated to be within a range of radiation scattered from the first source and the second source by an environment of the formation.

### CROSS-REFERENCE TO RELATED APPLICATIONS

This application claims the benefit of U.S. Provisional Patent Application Ser. No. 62/098,325, filed on Dec. 30, 2014 and which is hereby incorporated by reference in its entirety.

### BACKGROUND

Generators of various types of nuclear radiation can be useful for evaluating underground formations. These generators may include neutron generators, gamma ray generators, X-ray generators, etc. One reason why different types of generators are used is that each type of radiation has its own unique scattering characteristics when it encounters various materials. Thus, several different types of radiation can often be used to get a more accurate picture of a possible composition of a particular area in a formation.

In many instances, current commercial downhole tools for measuring density use chemical sources to generate radiation. Such sources can create a constant background of radiation such that it is often desirable to conduct other radiation measurements, including natural gamma ray measurements, relatively far away in order to avoid cross contamination.

### SUMMARY

Collocated radiation sensing in the presence of two or more nuclear radiation sources is provided. In one possible implementation, a tool to be placed in a wellbore includes a first source of nuclear radiation and a second source of nuclear radiation. The tool also includes one or more sensors configured to discriminate between radiation emitted by the first and second sources and correctly attribute the radiation to the source from which the radiation was emitted. The one or more sensors are collocated to be within a range of radiation scattered from the first source and the second source by an environment of the formation.

In some implementations, a method of implementing a burst sequence includes directing a first radiation source to emit a first burst of nuclear radiation and instigating a first time window. Radiation detected by one or more sensors during the first time window is associated with the first radiation source. The method further includes directing a second radiation source to emit a second burst of nuclear radiation after the first time window has elapsed. A second time window is instigated such that its duration is predominately after the second burst and radiation detected by the one or more sensors during the second time window is associated with the second radiation source. In some examples, the second time window is instigated after the second burst commences, while in some examples the second time window is instigated at the same time or slightly before the commencement of the second burst.

In some implementations, a burst sequence is implemented by directing a first radiation source to emit a first burst of nuclear radiation. Then at some point in time after a commencement of the first burst, a commencement and conclusion of a first time window is instigated and radiation detected by one or more sensors during the first time window is attributed to the first radiation source. After the conclusion of the first time window, a second radiation source is directed to emit a second burst of nuclear radiation and a commencement and conclusion of a second time window is instigated at some point in time after a commencement of the second burst. Radiation detected by one or more sensors during the second time window is attributed to the second radiation source.

This summary is not intended to identify key or essential features of the claimed subject matter, nor is it intended to be used as an aid in limiting the scope of the claimed subject matter.

### BRIEF DESCRIPTION OF THE DRAWINGS

Aspects of example implementations can be more readily understood by reference to the following description taken in conjunction with the accompanying drawings.

FIG. 1 illustrates an example wellsite in which embodiments of collocated radiation sensing can be employed.

FIG. 2 illustrates an example computing device that can be used in accordance with various implementations of collocated radiation sensing.

FIG. 3 illustrates an example collocated radiation sensing system in accordance with implementations of collocated radiation sensing.

FIG. 4 illustrates another example collocated radiation sensing system in accordance with implementations of collocated radiation sensing.

FIG. 5 illustrates an example burst sequence in accordance with implementations of collocated radiation sensing.

FIG. 6 illustrates an example method associated with collocated radiation sensing.

FIG. 7 illustrates an example method associated with collocated radiation sensing.

### DETAILED DESCRIPTION

In the following description, numerous details are set forth to provide an understanding of some embodiments of the present disclosure. However, it will be understood by those of ordinary skill in the art that the systems and/or methodologies may be practiced without these details and that numerous variations or modifications from the described embodiments may be possible.

Additionally, some examples discussed herein involve technologies associated with the oilfield services industry. It will be understood however that the techniques of collocated radiation sensing can be used in a wide range of industries outside of the oilfield services sector, including for example, mining, geological surveying, medical imaging, etc.

As described herein, various techniques and technologies associated with collocated radiation sensing can facilitate the measurement of nuclear radiation from two or more sources using one or more sensors. In some implementations this can be accomplished by placing the one or more sensors at locations that can be expected to be within reach of scattered radiation associated with radiation emitted by the two or more sources. In some implementations at least one sensor is shared between measurements with two or more sources.

Additionally, in some implementations, the sources of nuclear radiation may be pulsed sources, and each source can emit a pulse when the other sources are in burst off mode. In this way the scattered radiation associated with each pulse can be detected, and with some probability, correctly attributed to the source that emitted it.

In some implementations, one or more of the sources can be a steady state source, sharing a common far detector (i.e. a collocated sensor) configured to sense and discern nuclear radiation from each source, such that the nuclear radiation, with some probability, can be correctly attributed to the source with which it is associated.

### Example Wellsite

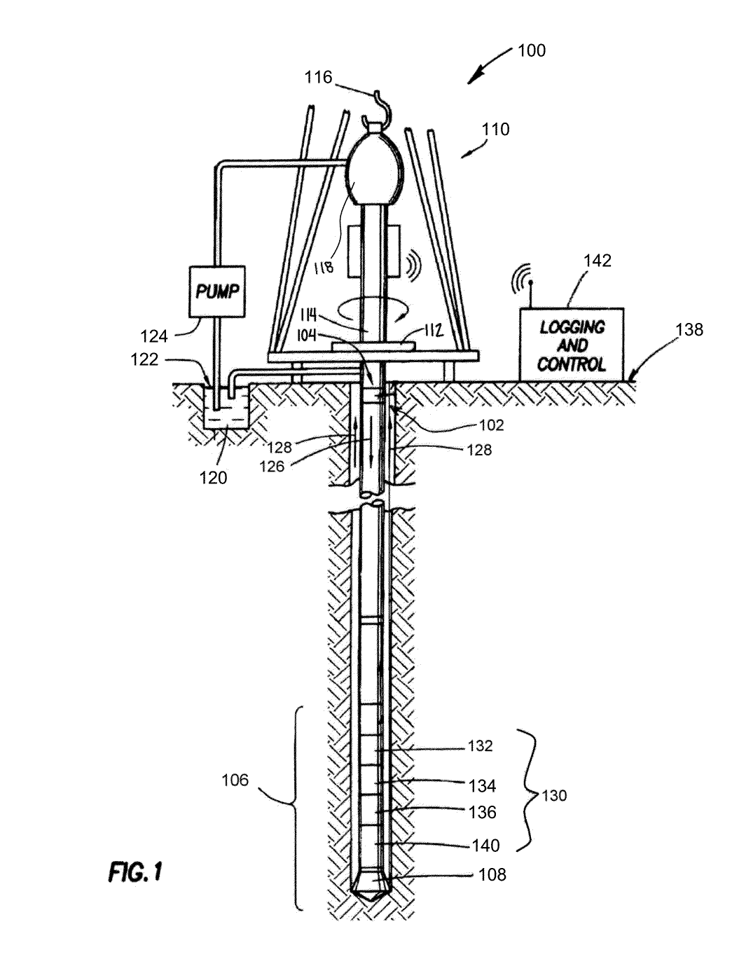

FIG. 1 illustrates a wellsite 100 in which implementations of collocated radiation sensing can be employed. Wellsite 100 can be onshore or offshore. In this example system, a borehole 102 is formed in a subsurface formation by rotary drilling in a manner that is well known. Embodiments of collocated radiation sensing can also be employed in association with wellsites where directional drilling is being conducted.

A drill string 104 can be suspended within borehole 102 and have a bottom hole assembly 106 including a drill bit 108 at its lower end. The surface system can include a platform and derrick assembly 110 positioned over the borehole 102. The assembly 110 may include a rotary table 112, kelly 114, hook 116 and rotary swivel 118. The drill string 104 can be rotated by the rotary table 112 (energized by any suitable mechanism), which engages kelly 114 at an upper end of drill string 104. Drill string 104 may be suspended from hook 116, attached to a traveling block (also not shown), through kelly 114 and a rotary swivel 118 which can permit rotation of drill string 104 relative to hook 116. As is well known, a top drive system can also be used.

In the example of this embodiment, the surface system can further include drilling fluid or mud 120 stored in a pit 122 formed at wellsite 100. A pump 124 can deliver drilling fluid 120 to an interior of drill string 104 via a port in swivel 118, causing drilling fluid 120 to flow downwardly through drill string 104 as indicated by directional arrow 126. Drilling fluid 120 can exit drill string 104 via ports in drill bit 108, and circulate upwardly through the annulus region between the outside of drill string 104 and wall of the borehole 102, as indicated by directional arrows 128. In this well-known manner, drilling fluid 120 can lubricate drill bit 108 and carry formation cuttings up to the surface as drilling fluid 120 is returned to pit 122 for recirculation.

Bottom hole assembly 106 of the illustrated example can include drill bit 108 as well as a variety of equipment 130, including a logging-while-drilling (LWD) module 132, a measuring-while-drilling (MWD) module 134, a roto-steerable system and motor, various other tools, etc.

In some implementations, LWD module 132 can be housed in a special type of drill collar, as is known in the art, and can include one or more of a plurality of known types of logging tools (e.g., a nuclear magnetic resonance (NMR system), a directional resistivity system, and/or a sonic logging system). It will also be understood that more than one LWD and/or MWD module can be employed (e.g. as represented at position 136). (References, throughout, to a module at position 132 can also mean a module at position 136 as well). LWD module 132 can include capabilities for measuring, processing, and storing information, as well as for communicating with surface equipment.

MWD module 134 can also be housed in a special type of drill collar, as is known in the art, and include one or more devices for measuring characteristics of the well environment, such as characteristics of the drill string and drill bit. MWD module 134 can further include an apparatus for generating electrical power to the downhole system. This may include a mud turbine generator powered by the flow of drilling fluid 120, it being understood that other power and/or battery systems may be employed. MWD module 134 can include one or more of a variety of measuring devices known in the art including, for example, a weight-on-bit measuring device, a torque measuring device, a vibration measuring device, a shock measuring device, a stick slip measuring device, a direction measuring device, and an inclination measuring device.

It will be understood that a variety of sources configured to emit nuclear radiation can be included in equipment 130. These sources can be located on their own, located entirely or partially in LWD module 132, located entirely or partially in MWD module 134, or any combination thereof. In some implementations, one or more nuclear radiation sources can be located on various tools and instruments lowered into borehole 102, including wireline tools, etc. Also, one or more of the nuclear radiation devices can include sources of nuclear radiation which can be pulsed in a burst sequence allowing at least one sensor to detect radiation from several nearby radiation sources. In one possible implementation, a burst sequencer can be used to attribute the radiation received by the at least one sensor to the source from which it was emitted.

Various embodiments of the present disclosure can be associated with systems and methods for transmitting information (data and/or commands) from equipment 130 to a surface 138 of the wellsite 100. In one implementation, the information can be received by one or more sensors 140. The sensors 140 can be located in a variety of locations and can be chosen from any sensing and/or detecting technology known in the art, including those capable of measuring various types of radiation, electric or magnetic fields, including electrodes (such as stakes), magnetometers, coils, etc.

In one possible implementation, sensors 140 receive information from equipment 130, including LWD data and/or MWD data, which can be utilized for a variety of purposes including steering drill 108 and any tools associated therewith, characterizing a formation surrounding borehole 102, characterizing fluids within wellbore 102, etc.

In one implementation a logging and control system 142 can be used to coordinate sensors 140 and/or associate information detected by sensors 140 with radiation emitted by various sources of nuclear radiation. Logging and control system 142 can also be used with a wide variety of oilfield applications, including logging while drilling, artificial lift, measuring while drilling, wireline, etc. Also, logging and control system 142 can be located at surface 138, below surface 138, proximate to borehole 102, remote from borehole 102, or any combination thereof.

Alternately, or additionally, information received by sensors 140 can be processed at one or more other locations, including, for example, any configuration known in the art, such as in one or more handheld devices proximate and/or remote from the wellsite 100, at a computer located at a remote command center, in the logging and control system 142 itself, etc.

### Example Computing Device

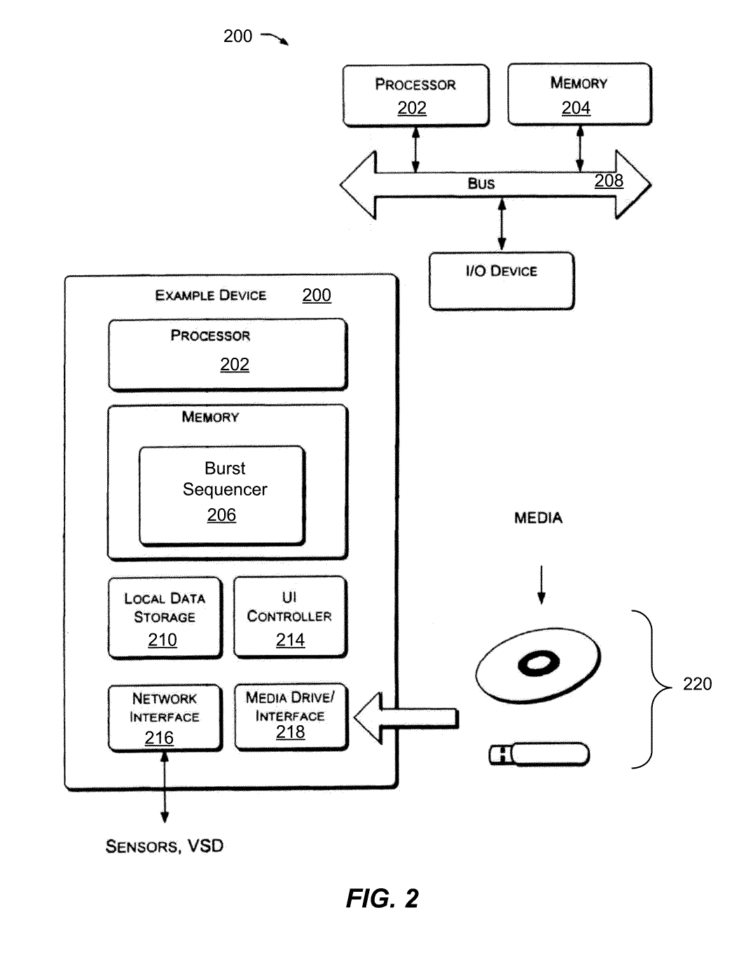

FIG. 2 shows an example device 200, with a processor 202 and memory 204 for hosting a burst sequencer 206 configured to implement various embodiments of collocated radiation sensing as discussed in this disclosure. Memory 204 can also host one or more databases and can include one or more forms of volatile data storage media such as random access memory (RAM)), and/or one or more forms of nonvolatile storage media (such as read-only memory (ROM), flash memory, and so forth).

Device 200 is one example of a computing device or programmable device, and is not intended to suggest any limitation as to scope of use or functionality of device 200 and/or its possible architectures. For example, device 200 can comprise one or more computing devices, programmable logic controllers (PLCs), etc.

Further, device 200 should not be interpreted as having any dependency relating to one or a combination of components illustrated in device 200. For example, device 200 may include one or more of a computer, such as a laptop computer, a desktop computer, a mainframe computer, etc., or any combination or accumulation thereof.

Device 200 can also include a bus 208 configured to allow various components and devices, such as processors 202, memory 204, and local data storage 210, among other components, to communicate with each other.

Bus 208 can include one or more of any of several types of bus structures, including a memory bus or memory controller, a peripheral bus, an accelerated graphics port, and a processor or local bus using any of a variety of bus architectures. Bus 208 can also include wired and/or wireless buses.

Local data storage 210 can include fixed media (e.g., RAM, ROM, a fixed hard drive, etc.) as well as removable media (e.g., a flash memory drive, a removable hard drive, optical disks, magnetic disks, and so forth).

A input/output (I/O) device 212 may also communicate via a user interface (UI) controller 214, which may connect with I/O device 212 either directly or through bus 208.

In some implementations, a network interface 216 may communicate outside of device 200 via a connected network, and in some implementations may communicate with hardware, such as one or more sensors 140, sources configured to emit nuclear radiation, etc.

In some implementations, sensors 140 may communicate with system 200 as input/output devices 212 via bus 208, such as via a USB port, for example.

A media drive/interface 218 can accept removable tangible media 220, such as flash drives, optical disks, removable hard drives, software products, etc. In some implementations, logic, computing instructions, and/or software programs comprising elements of the burst sequencer 206 may reside on removable media 220 readable by media drive/interface 218.

In some implementations, input/output devices 212 can allow a user to enter commands and information to device 200, and also allow information to be presented to the user and/or other components or devices. Examples of input devices 212 include, for example, sensors, a keyboard, a cursor control device (e.g., a mouse), a microphone, a scanner, and any other input devices known in the art. Examples of output devices include, for example, a display device (e.g., a monitor or projector), speakers, a printer, a network card, and so on.

Various processes of burst sequencer 206 may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media may be any available data storage medium or media that is tangible and can be accessed by a computing device. Computer readable media may thus include computer storage media. “Computer storage media” designates tangible media, and includes volatile and non-volatile, removable and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

### Example System(s)

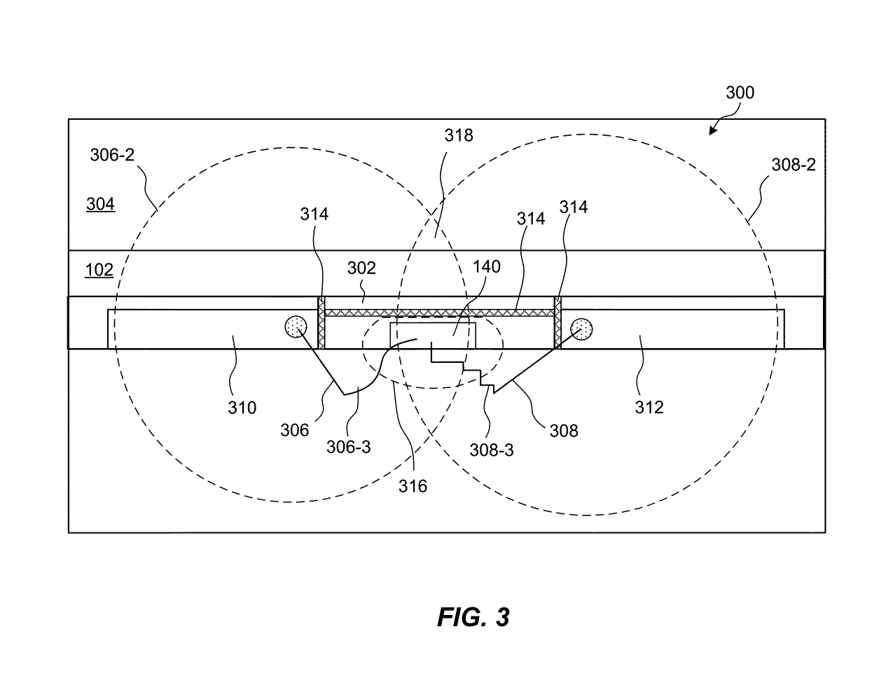

FIG. 3 illustrates an example collocated radiation sensing system 300 in accordance with implementations of collocated radiation sensing. As shown, a formation evaluation tool 302 including one or more sensors 140 can be deployed in borehole 102 in a formation 304, such as a geologic formation. Formation evaluation tool 302 can include anything that can be placed in borehole 102, including a bottom hole assembly 106, various equipment 130, wireline tools, slickline tools, etc.

In some implementations, the one or more sensors 140 are placed on tool 302 within the range of secondary radiation 306-3, 308-3 from a first primary radiation 306 emitted by a first source of nuclear radiation 310 and a second primary radiation 308 emitted by a second source of nuclear radiation 312. The reach of the secondary radiation caused by source 310 is symbolized by radiation cloud 306-2 and the reach of the secondary radiation of source 312 is symbolized by radiation cloud 308-2.

Secondary radiation 306-3, 308-3 includes radiation from first primary radiation 306 and second primary radiation 308 that has been scattered back to sensors 140 by formation 304 (including gases and/or liquids in formation 304, etc.). This can include, for example, scattered gamma rays, scattered neutrons, etc. As used herein, secondary radiation should be understood to include elastically scattered particles in addition to other radiation commonly understood to be secondary.

Sources of nuclear radiation 310, 312 may include any radiation sources known in the art, including pulsed and static sources, and can emit any nuclear radiation known in the art, including neutrons, gamma rays, X-rays, etc. Moreover, sources of nuclear radiation 310, 312 may emit the same type of radiation or different kinds of radiation.

For example, in some implementations, a Deuterium-Tritium (DT) pulsed neutron source emitting, for example, 14 MeV neutrons can be used. In another possible implementation, a Cesium-137 logging source (not pulsed) emitting, for example, 662 keV gamma rays, may be used.

In some implementations, a pulsed neutron generator (PNG) can be used in close proximity with a pulsed X-ray generator (PXG). In such a manner, one or more neutron measurements such as, for example, neutron porosity, sigma, and spectroscopy, can be made, and a formation density measurement can also be made collocated.

The one or more sensors 140 may be designed to detect and/or measure radiation from the sources of nuclear radiation 310, 312 which has been scattered by formation 304 (including gases and/or liquids in formation 304 etc.). For example the one or more sensors 140 may include one or more of a scintillation detector, a position sensitive detector, a gas detector, a solid-state detector, etc. Moreover, the one or more sensors 140 can include an array of similar or different detectors. In some implementations, sensors 140 can measure and correctly attribute secondary radiation 306-3, 308-3 scattered by formation 304, gases and/or liquids in borehole 102, etc., to the source of nuclear radiation 310, 312 by which the primary radiation 306, 308 was originally emitted. This attribution functionality can include any technology known in the art.

Sensors 140 may be protected from direct exposure to primary radiation 306, 08 of sources of nuclear radiation 310, 312 by one or more radiation shields 314. In some implementations, radiation shields 314 can be constructed from a dense material, such as tungsten, for example. It is also possible that several sources of nuclear radiation 310, 312 can be located together, separated from sensors 140 by the same radiation shield 314.

In some implementations, radiation in radiation clouds 306-2, 308-2 can lose energy when it is scattered. For example, primary neutrons in radiation clouds 306-2, 308-2 may have energy on the order of mega electron-volts (such as, for example 14 MeV), but after being scattered by formation 304, gases and/or liquids, etc., the neutrons in the resulting secondary radiation 306-3, 308-3 may have less than an electron-volt of energy.

In some implementations, a sensitivity of sensors 140 along with a type and amount of energy in secondary radiation 306-3, 308-3 can define a volume of sensitivity 316 of each sensor 104 (i.e. a space around each sensor 140 in which the sensor 140 can receive and measure secondary radiation 306-3, 308-3). In some implementations, the volume of sensitivity is different for the different secondary radiation 306-3 and 308-3.

In some implementations, volume of sensitivity 316 for a given sensor 140 can be mapped out using factors such as, for example, the sensitivity of the sensor 140 to radiation emitted by sources of nuclear radiation 310, 312 and/or the sensitivity of the sensor 140 to secondary radiation 306-3, 308-3, etc. In one possible aspect, volume of sensitivity 316 can be computed with any computer modeling software known in the art capable of creating a sensitivity map.

In some instances, volume of sensitivity 316 for a sensor 140 can be an irregular shaped volume near sensor 140 but mostly outside of tool 302. In some implementations, it may be desirable to design tool 302 (including placement of sensors 140 and shielding 314) to increase and/or optimize the amount of volume of sensitivity 316 outside of tool 302 in formation 304.

As noted above, it may be desirable to have a sensor 140 with a volume of sensitivity 316 configured to receive secondary radiation 306-3, 308-3 from both radiation cloud 306-2 and radiation cloud 308-2. Such a sensor 140 can be said to be collocated, since it can potentially measure radiation from more than one source of nuclear radiation 310, 312 scattered by formation 304 (including gases and/or liquids, etc.).

In some implementations, sensor 140 may be deliberately placed on tool 302 in a location to increase and/or maximize volume of sensitivity 316. Additionally, more than one sensor 140, and therefore more than one volume of sensitivity 316 may be employed on tool 302.

In some implementations, sensor 140 may be placed in an area of overlap 318 of first radiation cloud 306-2 and second radiation cloud 308-2.

The wide variety of possible sources of nuclear radiation 310, 312 can enable a variety of different measurements to be made including, for example, gamma-gamma density, X-ray density, neutron porosity, neutron-gamma spectroscopy, formation sigma, slowing down time, and so on, including any combination thereof.

Additionally, a mixture of static and pulsed sources of nuclear radiation 310, 312 may be employed. This includes use of two or more static sources of nuclear radiation 310, 312, use of two or more pulsed sources of nuclear radiation 310, 312, or use of any possible combination of static and pulsed sources of nuclear radiation 310, 312.

For example, a collocated sensor 140 (also known as an overlapping sensor 104) can be used to make a gamma source based measurement, for example gamma density measurements, from source 310, and a neutron source based measurement, for example neutron porosity measurements, from source 312 and correctly attribute these forms of secondary radiation 306-3, 308-3 to the sources of nuclear radiation 310, 312 from which the primary radiation 306, 308 were originally emitted. In some implementations, sources of nuclear radiation 310, 312 can emit radiation at the same time. In some implementations, sources of nuclear radiation 310, 312 may emit radiation at different times, such that when one source is emitting radiation the other source isn't. In some implementations, sources of nuclear radiation 310, 312 may sometimes emit radiation at the same time, and sometimes emit radiation at different times.

In some implementations, each measurement made by sensor 140 may be conducted in accordance with its own unique time scale and/or timing sequence. This can be used, when desirable, to accommodate characteristics of the various types of radiation associated with sources of nuclear radiation 310, 312. For example, gamma rays can be scattered almost instantaneously, and therefore associated secondary radiation 306-3, 308-3 can be detected by sensor 140 while the emission of radiation from a source 310, 312 from which the gamma rays originated is still ongoing. Similarly, a sigma measurement (based on, for example, thermal neutrons) may be conducted over a longer time scale (such as, for example, 100 microseconds or more). Thus a radiation burst from a source 310, 312 associated with the sigma measurement can be held comparatively short (for example the burst can last 10 microseconds or so), with associated secondary radiation 306-3, 308-3 being measured by sensors 140 after conclusion of the burst. In some implementations, a delay may exist between the burst and measurement to allow for the slowing down of remaining fast neutrons.

As noted above, more than two sources of radiation 310, 312 can be employed in system 300. In which case, the at least one collocated sensor 140 may be placed at a location within range of secondary radiation from each of the various sources of nuclear radiation present.

Measurements made by sensors 140 can be augmented when other tools are used along with the sources of nuclear radiation 310, 312 and their associated one or more sensors 140.

For example a triple-combo measurement comprising a density measurement, a neutron measurement, and a resistivity measurement may be made. In some implementations, a triple-combo measurement may be used in conjunction with a neutron-gamma spectroscopy measurement.

In some implementations, when both a pulsed X-ray source and a pulsed neutron source are used as sources of nuclear radiation 310, 312, a sensor 140 that is sensitive to both X-rays and gamma rays may be employed. In some such implementations the sensor responds differently to at least two different types of radiation. In some implementations, sensor 140 can be a scintillation detector employing an elpasolite scintillator material such as Ce-doped Cs₂LiYCl₆ (CLYC).

It will also be understood that one or more of sources of nuclear radiation 310, 312 can be designed for one kind of radiation while emitting and/or causing other types of radiation as well. For example a pulsed neutron source may emit secondary slower neutrons (slightly delayed over burst) as well as inelastic (instantaneous) and capture (delayed) gamma rays. In some implementations, all the types of radiation associated with a source 310, 312, including the designed for radiation and the one or more other types of radiation caused by the source, may be detected, once scattered, by sensors 140.

It will be understood that in addition to being placed on tool 302, the at least one sensor 140 can also be placed on other equipment 130, in borehole 102, in formation 304, or any combination thereof. For example, one or more sensors 140 can be found on tool 302, other equipment 130, in borehole 102, and in formation 304.

Similarly, sources of radiation 310, 312 can be located other places than simply tool 302. For example, one or more of sources of radiation 310, 312 can be found on tool 302, other equipment 130, in borehole 102, in formation 304, or any combination thereof.

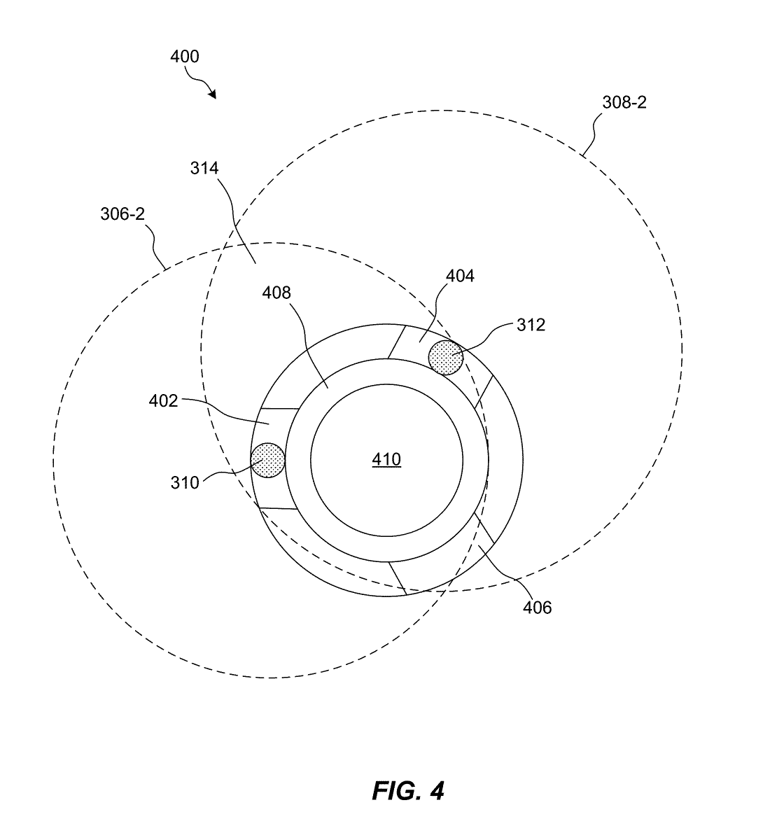

FIG. 4 illustrates another example collocated radiation sensing system 400 in accordance with implementations of collocated radiation sensing. In FIG. 4, three stabilizer blades 402, 404, 406 are positioned around a drill collar 408 on a tool chassis 410. In one possible implementation, stabilizer blades are associated with equipment 130, such as, for example LWD module 132.

As shown, sources of radiation 310, 312 are deployed on stabilizer blades 402 and 404 respectively. It will be understood that more or less stabilizer blades could be employed. It will also be understood that more sources of radiation could be employed.

In some implementations one or more sensors 140 are collocated with respect to the position along the tool axis, and can be used to measure radiation from sources of radiation 310, 312. This could, in some examples, mean the one or more collocated sensors 140 may be located in one or more of a variety of locations, such as stabilizer 402, stabilizer 404, drill collar 408, etc. It is understood that a variety of characteristics of the associated radiation clouds 306-2, 308-2 including, for example, shape, range, strength, etc., will vary based on where sources of nuclear radiation 310, 312 are deployed. (i.e. where on tool 302 or equipment 130 the sources of nuclear radiation 310, 312 are deployed, in what environment sources of nuclear radiation 310, 312 are deployed, etc.). Additionally, these same factors may also affect a range of secondary radiation 306-3, 308-3.

Returning to FIG. 3, in some implementations, in addition to one or more collocated sensors 140 configured to take collocated measurements by measuring and/or detecting scattered radiation from several sources of nuclear radiation 310, 312 (such as long spaced sensors, for example) other sensors (such as short spaced sensors, for example) can be present and placed such that they are at least somewhat in a radiation cloud 306-2, 308-2 of a single source of nuclear radiation (such as 310 and 312, respectively). In some implementations, short spaced sensors can be used with long spaced sensors 140 to correct for borehole effects.

For example, short spaced sensors may be placed in the range of radiation cloud 306-2 but not in the range of radiation cloud 308-2. In some implementations, this could mean that a short spaced sensor can be employed to measure radiation from source of nuclear radiation 310 and not source of nuclear radiation 312.

Similarly, a short spaced sensor can be placed in the range of radiation cloud 308-2 but not in the range of radiation cloud 306-2. In one possible implementation, this could mean that the short spaced sensor can be employed to measure radiation from pulsed source of nuclear radiation 312 and not pulsed source of nuclear radiation 310.

### Example Burst Sequences

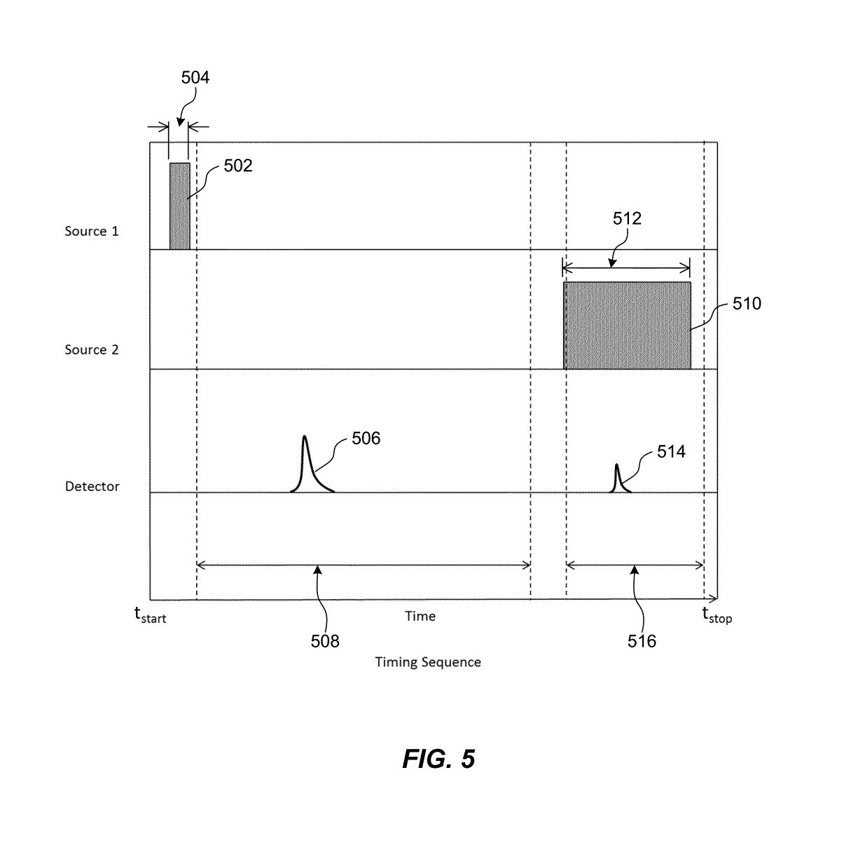

FIG. 5 illustrates an example burst sequence 500 for use with multiple sources of nuclear radiation in accordance with implementations of collocated radiation sensing. As shown, a first burst 502 can be triggered at pulsed source of nuclear radiation 310 and last for a duration of time 504. The radiation from first burst 502 can interact with, and be scattered by, an environment outside pulsed source of nuclear radiation 310 (including formation 304, gases and fluids inside wellbore 102, etc.). The scattered radiation (i.e. secondary radiation 306-3) can be detected and registered at one or more collocated detectors 140 as a first event 506. If the first event 506 is falling into a first time window 508 it is with some likelihood associated with pulsed source of nuclear radiation 310. It will be noted that events are statistically distributed and that therefore more than one event 506 may be registered within time window 508. It will also be noted that an event may be absent and it will be registered as a zero event within the time window 508.

Then, after the first time window 508 has elapsed, a second burst 510 can be triggered at pulsed source of nuclear radiation 312 and last for a duration of time 512. The radiation from second burst 510 can interact with, and be scattered by, the environment outside pulsed source of nuclear radiation 312 (including formation 304, gases and fluids inside wellbore 102, etc.).

The scattered radiation (i.e. secondary radiation 308) can be detected and registered as a second event 514 at one or more collocated detectors 140.

Though bursts 502, 510 from two different sources of nuclear radiation 310, 312 are illustrated in FIG. 5, it will be understood that more sources of nuclear radiation can be used. In some implementations, each additional burst from an additional pulsed source of nuclear radiation can be associated with its own time window to allow for an accurate detection and registration of an event associated with the burst, using the various methods discussed herein.

In some cases, the time window is after the burst, while in other cases, such as for example, when gamma rays are emitted (gamma rays can be scattered almost instantaneously), the associated time window can begin during the burst of gamma rays such that associated secondary radiation 306, 308 can be detected by sensor 140 while the emission of gamma rays from their source 310, 312 is still ongoing. It will be understood that the majority of the time window will happen during or after the burst, but that to adjust for the accuracy of timing or timing jitter the time window may even be started just before the burst.

It will also be understood that the shapes of bursts 502, 510 need not be rectangular. Instead, one or more of bursts 502, 510 can have a visible rise and/or a visible fall time. For neutron sources, for example, rise and fall times can comprise a fraction of a microsecond.

Moreover, durations and positions within the time sequence of the first and second time windows 508, 516 and possibly additional waiting periods can be set to allow emitted radiation to die down before subsequent bursts 502, 510. For example, first time window 508 and the waiting period after the time window 508 can be set to be long enough to allow radiation emitted during first burst 502 to decay such that it will not interfere significantly with the one more sensors 140 as they detect radiation from burst 510. Similarly, second time window 516 and the waiting period after the time window 516 can be set to be long enough to allow radiation emitted during second burst 510 to decay such it will not interfere with one more sensors 140 as they detect radiation from burst 502.

The durations of first and second time windows 508, 516 can be set manually, or automatically (including on the fly) and can be varied for a variety of reasons. In one possible embodiment, the durations of first and second time windows 508, 516 can be set and/or varied by burst sequencer 206. In one possible aspect, this can happen automatically and/or through human intervention.

For example, the durations of first and second time windows 508, 516 can be set to improve an accuracy of registered events 506, 514 and/or improve a probability that event 506 corresponds to burst 502, and event 514 corresponds to burst 510.

Given that a synchronization signal, such as from burst sequencer 206, coordinating bursts 502, 510, time windows 508, 516, and their associated measurements may be fanned out to different electronics boards, etc., the timing of the synchronization signal may be off by a fraction of a microsecond or more due to cable and/or electronic delays. In one possible implementation, to mitigate the effects of such latency, a short time delay can be added as an extra time window on the front and/or back end of each burst 502, 510.

Additionally, in some instances the physics of interactions between radiation emitted from sources 310, 312 and an environment (including formation 304, gases and fluids inside wellbore 102, etc.) may result in one or more unwanted types of secondary radiation. For example after a fast neutron burst many neutrons of intermediate energy may be present that can interact with sensor 140 and result in erroneous measurements. Delays or additional time windows, like time windows 508, 516, can be added to mitigate the measurement of such unwanted secondary radiation by sensors 140.

Some measurements by sensors 140 may be delayed more than others. For example in a neutron spectroscopy tool, three different windows can be defined: an early capture gate, a late capture gate, and a sigma or tau gate.

In some implementations, the probability that an event 506, 514 corresponds to a given burst 502, 510 can be less than 100%. This can arise, for example, when a background radiation event is associated with one or more of sources of nuclear radiation 310, 312. It can also be the case in the presence of artificial events for example from electronic noise.

In some implementations, the probability that an event 506, 514 corresponds to a given burst 502, 510 can be rounded to 100% if the probability is high, and to 0% if the probability is low. In one possible aspect high can mean above 95%, and low can mean below 5%, though these ranges may be adjusted in any way desired. Handling of probabilities in this manner can lead to a time window 508, 516 being positively identified with one of the two sources of nuclear radiation 310, 312.

The durations of first and second time windows 508, 516 can also be set based on the types of radiation and/or strengths of radiation being emitted from sources of nuclear radiation 310, 312. Additionally, first and second time windows 508, 516 can be set based on conditions in wellbore 102 and/or formation 304.

Similarly, durations 504, 512 of bursts 502, 510 can also be set manually or automatically (including on the fly) and can be varied for a variety of reasons. In one possible embodiment, durations 504, 512 can be set and/or varied by burst sequencer 206.

For example, durations 504, 512 can be set to extend operating lives of various equipment (such as operating lives of pulsed source of nuclear radiation 310 and/or pulsed source of nuclear radiation 312). Further durations 504, 512 can be set to coincide with various other operating characteristics of equipment being used, including to coincide with natural and/or designed pulse lengths of a pulsed source of nuclear radiation being used. Durations 504, 512 can also be set based on the types of radiation and/or strengths of radiation being emitted from sources of nuclear radiation 310, 312. Additionally, durations 504, 512 can be set based on conditions in wellbore 102 and/or formation 304.

As shown in FIG. 5, time window 508 commences after the end of corresponding burst 502 and time window 516 commences during burst 510. It will be understood, that time windows 508, 516 can commence at other points as well including anywhere within their associated bursts 502, 510. In one possible implementation, the commencement of a time window can be determined based on how quickly radiation emitted from sources of nuclear radiation 310, 312 is scattered and available to be measured by sensor 140. For example, radiation emitted in burst 510 is scattered and available at sensor 140 during burst 510, so window 516 can commence during burst 510.

In some implementations, after a second time window 516 has elapsed, burst sequence 500 can be repeated resulting in another triggering of first and second bursts 502, 510 and another detection and registering of a second set of first and second events 506, 514 as described above. In this way many sets of first and second events 506, 514 can be detected and registered, giving an operator a large set of data to examine and manipulate.

Also, even though FIG. 5 shows that sources of nuclear radiation 310, 312 alternate bursts 502, 510, it will be understood that one source of nuclear radiation can fire off bursts in any order possible including having one source of nuclear radiation fire off several bursts in a row. For instance multiple bursts of a neutron source can be followed by one or more bursts from an X-ray source.

Moreover, multiple time windows may be used with a burst 502, 510 to measure and differentiate between various secondary radiation components. For example, in one possible implementation, burst 502 may result in the scattering of several types of radiation. A first time window may be established to measure the most quickly scattered radiation, with subsequent windows being established to measure other, later scattered radiation. In one aspect, all such windows would elapse before burst 510 is triggered.

In some implementations, various windows can exist to allow for functioning of various types of sources 310, 312. For example a neutron source may have a time window b that is associated with the burst (called a burst gate), a second time window c that is associated with timing right after the burst (called a capture gate) and a time window s delayed after the end of the burst (called a sigma gate).

In some implementations, after a desired number of burst sequences 500 have been undertaken, a rest cycle can be instigated for a desired rest period. In one implementation, the rest cycle can happen after the completion of burst sequence 500, such as after an end of second time window 516. In other implementations, the rest cycle can happen at any point during burst sequence 500.

In some implementations, the rest cycle can be instigated to rest system components like detectors 140, sources of nuclear radiation 310, 312, and/or equipment 130, etc. In another possible embodiment, the rest cycle can be instigated to allow radiation from sources of nuclear radiation 310, 312 to die down so that background radiation in proximity of sensor(s) 140 can be measured. In one aspect, background radiation measured in this way can be used to refine and further improve an accuracy of measurements of radiation from sources of nuclear radiation 310, 312 detected by sensors 140 in previous and/or future burst sequences 500.

In some implementations, any of the facets involved in implementing and/or altering burst sequence 500 described herein, including implementing one or more rest cycles, can be performed by burst sequencer 206. For example, in one possible implementation, burst sequencer 206 can include functionality to synchronize bursts 502, 510, with at least one collocated sensor 140 such that radiation induced by the activity of either of the sources of nuclear radiation 310, 312 may be detected in the at least one sensor 140 and registered as an event 506, 514. Similarly, burst sequencer 206 can include functionality to correlate the timing of an event 506, 514 with the timing of nearby bursts 502, 510 within burst sequence 500 in order to accurately associate the event 506, 514 with the correct pulsed source of nuclear radiation 310, 312 that emitted the radiation resulting in the event 506, 514.

For example, burst sequencer 206 can associate event 506 with burst 502 by noting that burst 502 was the last burst to occur before detection and registration of event 506, and that radiation from the last burst 510 can be viewed to have effectively dissipated because of a duration of window 516.

In some implementations, burst sequencer 206 can associate events 506, 514 with their corresponding bursts 502, 510 by assigning each event 506, 514 within a time window 508, 516 within burst sequence 500 a likelihood of being related to a pulsed source of nuclear radiation 310, 312. For example, since event 514 is in second time window 516 it can be assigned a higher likelihood of being associated with burst 510 (and therefore source of nuclear radiation 312) than burst 502 (and therefore source of nuclear radiation 310).

In some implementations, burst sequencer 206 can determine and/or instigate burst durations 504, 512 and time windows 508, 516 to decrease a chance of bursts 502, 510 interfering with one another. For example, burst sequencer 206 can determine and/or instigate burst durations 504, 512 and time windows 508, 516 such that radiation from burst 502 will decay before burst 510 occurs, and therefore not interfere with detection and registration of event 514 (and radiation from burst 510 will decay before burst 502 occurs and therefore not interfere with detection and registration of event 506).

In some implementations, burst sequencer 206 can tailor time windows 508, 516 to be long enough to decrease a chance of bursts 502, 510 interfering with one another, while the total time sequence is being short enough to not allow parameters susceptible to transience, such as fluid properties in an invasion zone, formation contact, cable tension in the case of a wireline measurement, etc., to change.

In some implementations, burst sequencer 206 can instigate burst sequence 500 by transmitting a common synchronization signal to sources of nuclear radiation 310, 312 and the one or more sensors 140. In some implementations, the common synchronization signal can include, for example, a single bit set when a counter of a clock signal reaches a certain number. In some examples burst sequence 500 is repeated each time burst sequencer 206 transmits the common synchronization signal to sources of nuclear radiation 310, 312 and the one or more sensors 140.

In some implementations, a clock speed may be periodic over certain intervals and varied in other intervals of burst sequence 500. For example, time around bursts 502, 510 may be clocked in periodic intervals (such as, for example, 1 microsecond intervals), while burst-off intervals may be clocked with lower resolution (such as, for example, millisecond resolution). In one possible aspect, a periodic master clock can keep track of the clocking mechanisms above.

In some implementations, a veto bit can be transmitted by burst sequencer 206 to override a bit starting the burst sequence 500. In one possible aspect, this can be equivalent to deactivating a pulsed source of nuclear radiation 310, 312 and one or more sensors 140 associated with a time period for which the veto bit is set.

In some implementations, each pulsed source of nuclear radiation 310, 312 can have an associated burst on and burst off period. For example, for pulsed source of nuclear radiation 310, the burst on duration is duration 504, and the burst off duration includes first time window 508, duration 512, second time window 516, and any other delay windows present.

In some implementations, burst sequencer 206 can set the burst on and burst off periods for one of sources of nuclear radiation 310, 312 by use of a single bit/flag. In some implementations, a signal to set the burst on and burst off periods for two sources of nuclear radiation 310, 312 may be combined into a word with two bits indicating a status of source of nuclear radiation 310 and of source of nuclear radiation 312.

Extending this further, in some implementations, the timing sequence of 1 to k sources of nuclear radiation can be described by a status work of k bits. In some implementations, a source status word of at least k bits can be created each time the timing sequence changes from one time window to another in a set of n time windows. In such an example, the word may include at least k*n bits.

In some implementations, an event 506, 514 can be tagged with a bit and/or flag indicating if the event 506, 514 was inside or outside of a given time window 508, 516 in burst sequence 500. Also, a flag can be set if a level or radiation received by a sensor 140 exceeds a preset threshold indicating a possibility of contamination (i.e. receipt of radiation from more than one source of radiation 310, 312).

In some implementations, additional parameters can be used to characterize events 506, 514, including pulse height discrimination, other measures distinguishing between different energies of detected radiation, etc.

In some implementations, a set flag can be dependent on a decay time of a pulse 502, 510. For example pulse shape discrimination can be used to distinguish between types of radiation from a single detector.

In some implementations, when m sensors are used a status word can include n or more bits per time window 508, 516. In such an instance, the combined status word can include m*n or more bits.

In some implementations, a status word within burst sequence 500 having 1 to k pulsed sources of nuclear radiation and 1-m sensors within 1-n time windows can be described by a status word of (k+m)*n or more bits. For instance, such a status word can be created for each repeat of burst sequence 500 from 1 to z.

In some implementations, burst sequencer 206 and computing device 200 can be downhole, such as in equipment 130, on the surface 138, such as in logging and control system. Alternately, portions of either both burst sequencer 206 and computing device 200 can exist downhole and on the surface 138, and all or some of the data used by burst sequencer 206 can be streamed to it, such as from sensors 140.

Example Methods

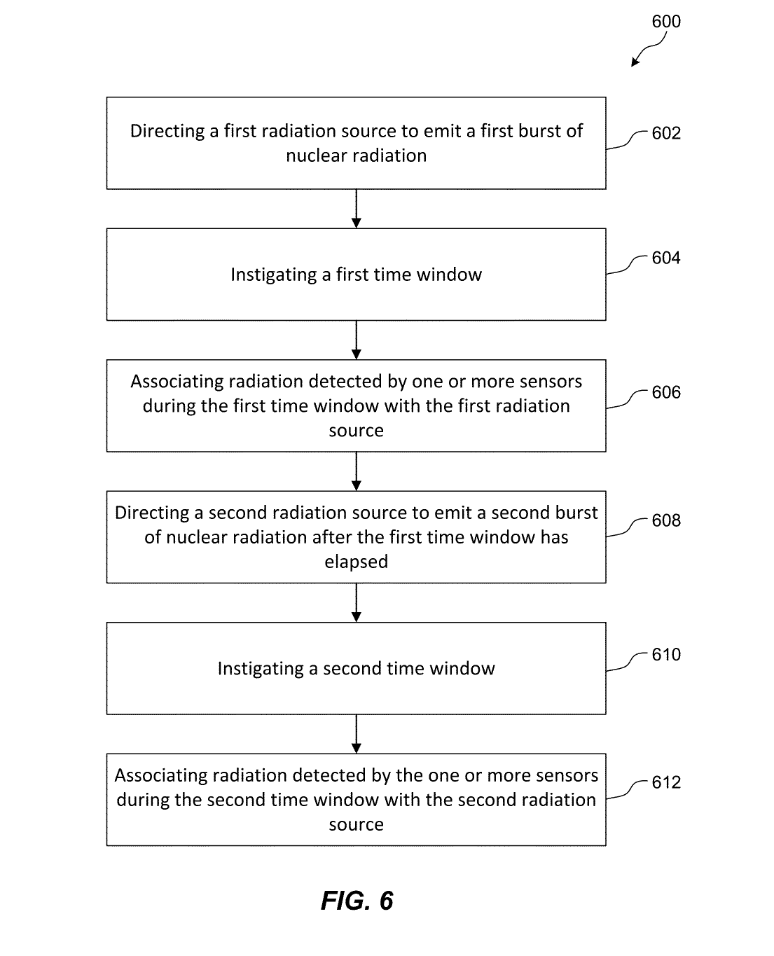

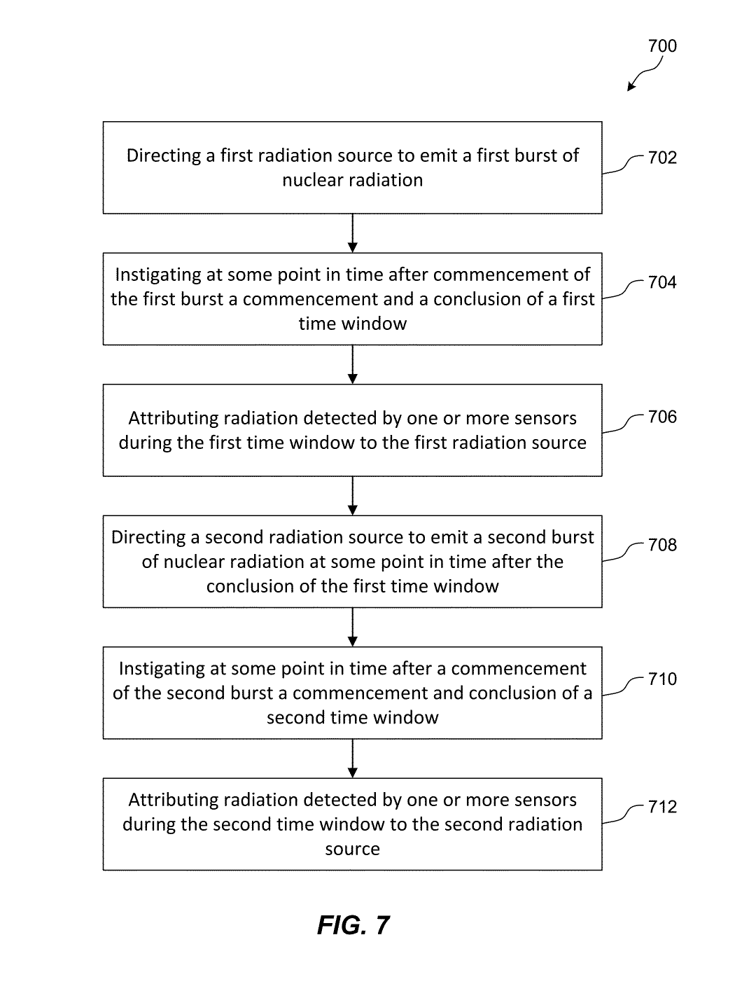

FIGS. 6-7 illustrate example methods for implementing aspects of collocated radiation sensing. The methods are illustrated as a collection of blocks and other elements in a logical flow graph representing a sequence of operations that can be implemented in hardware, software, firmware, various logic or any combination thereof. The order in which the methods are described is not intended to be construed as a limitation, and any number of the described method blocks can be combined in any order to implement the methods, or alternate methods. Additionally, individual blocks and/or elements may be deleted from the methods without departing from the spirit and scope of the subject matter described therein. In the context of software, the blocks and other elements can represent computer instructions that, when executed by one or more processors, perform the recited operations. Moreover, for discussion purposes, and not purposes of limitation, selected aspects of the methods may described with reference to elements shown in FIGS. 1-5.

FIG. 6 illustrates an example method 600 to implement a burst sequence, such as burst sequence 500, for use with multiple pulsed sources of nuclear radiation in accordance with implementations of collocated radiation sensing.

At block 602, a first radiation source such as source of radiation 310 is directed to emit a first burst, such as burst 502, of nuclear radiation. The first radiation source can emit any kind of radiation known in the art, and it can be directed to emit radiation by a sequencer, such as burst sequencer 206.

At block 604, a first time window is instigated, such as time window 508. In some implementations, the first time window can be designed to commence at some point in time before or after commencement of the first burst or at the same time as the commencement of the first burst, and last long enough to allow one or more sensors, such as sensors 140, to detect radiation from the first burst scattered by an environment associated with a formation such as formation 304.

At block 606, radiation detected by the one or more sensors during the first time window, such as event 506, is associated with the first radiation source. In some implementations the association is made by a sequencer, such as burst sequencer 206, using any of the various techniques described herein.

At block 608, a second radiation source, such as source of radiation 312, can be directed to emit a second burst, such as burst 510, of nuclear radiation after the first time window has elapsed. In one possible implementation, after the first time window means after the first time window and one or more delay periods.

As with the first radiation source above, the second radiation source can emit any kind of radiation known in the art, and it can be directed to emit radiation by a sequencer such as burst sequencer 206.

At block 610, a second time window is instigated, such as time window 516. In some implementations, the second time window can be designed to commence at some point in time before or after commencement of the second burst or at the same time as the commencement of the second burst, and last long enough to allow one or more sensors, such as sensors 140, to detect radiation from the second burst scattered by an environment associated with a formation, such as formation 304.

At block 612, radiation detected by the one or more sensors during the second time window is associated with the second radiation source. In one implementation the association is made by a sequencer, such as burst sequencer 206, using any of the various techniques described herein.

FIG. 7 illustrates an example method 700 to implement a burst sequence, such as burst sequence 500, for use with multiple pulsed sources of nuclear radiation in accordance with implementations of collocated radiation sensing.

At block 702, a first radiation source, such as source 310, is directed to emit a first burst, such as burst 502, of nuclear radiation. In one possible implementation, the first radiation source can emit any type of nuclear radiation known in the art. Moreover, the first radiation source can be directed to emit radiation by a sequencer, such as burst sequencer 206.

At block 704, at some point in time after a commencement of the first burst, a commencement and conclusion of a first time window, such as window 508) is instigated. In one possible implementation, the first time window commences at some point in time after commencement of the first burst, and lasts long enough to allow one or more sensors, such as sensors 140, to detect radiation from the first burst scattered by an environment associated with a formation, such as formation 304.

At block 706, radiation detected by the one or more sensors during the first time window can be attributed to the first radiation source. For example, an event, such as event 506, registered by one or more sensors, such as sensors 140, can be associated with the first radiation source using any of the methods discussed herein. In one implementation, this association can be performed by a burst sequencer, such as burst sequencer 206.

At block 708, a second radiation source, such as source 312, is directed to emit a second burst, such as burst 510, of nuclear radiation at some point in time after the conclusion of the first time window. In one possible implementation, the second radiation source can emit any type of nuclear radiation known in the art. Moreover, the second radiation source can be directed to emit radiation by a sequencer, such as burst sequencer 206.

At block 710, at some point in time after a commencement of the second burst, a commencement and conclusion of a second time window, such as window 516) is instigated. In one possible implementation, the second time window commences at some point in time after commencement of the second burst, and lasts long enough to allow one or more sensors, such as sensors 140, to detect radiation from the second burst scattered by an environment associated with a formation, such as formation 304.

At block 712, radiation received from the second burst by the one or more sensors can be attributed to the second radiation source. For example, an event, such as event 514, registered by one or more sensors, such as sensors 140, can be associated with the second radiation source using any of the methods discussed herein. In one implementation, this association can be performed by a burst sequencer, such as burst sequencer 206.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A downhole measurement system, comprising:
a tool configured to be placed in a wellbore, wherein the tool includes:
a first source of nuclear radiation;
a second source of nuclear radiation; and
one or more sensors configured to discriminate between radiation events caused by the first and second sources and correctly attribute the radiation event to the source from which the radiation was emitted;
wherein the one or more sensors are collocated such that they are within a range of a first type of secondary radiation resulting from primary radiation emitted by the first source interacting with an environment of the tool, and within a range of a second type of secondary radiation resulting from primary radiation emitted by the second source interacting with an environment of the tool.

2. The system of claim 1, wherein the tool comprises a bottom hole assembly.

3. The system of claim 1, wherein the tool comprises a wireline tool.

4. The system of claim 1, wherein the first source of nuclear radiation and the second source of nuclear radiation are separated by one or more radiation shields.

5. The system of claim 1, wherein one or more of the first source of nuclear radiation and the second source of nuclear radiation are static sources.

6. The system of claim 1, wherein one or more of the first source of nuclear radiation and the second source of nuclear radiation are pulsed sources.

7. The system of claim 1, wherein the system is configured to use response properties of the nuclear detector to discriminate between radiation events in the sensor and assign the radiation events to a source.

8. The system of claim 1, wherein at least one source is a pulsed source, and the system is configured to use timing of the events in the sensor relative to the pulse to discriminate between radiation events and assign the radiation events to a source.

9. The system of claim 1, wherein the radiation emitted by the first source of nuclear radiation and the second source of nuclear radiation include one or more of:
X-rays;
gamma rays;
neutrons.

10. The system of claim 1, further comprising:
a burst sequencer configured to initiate a burst sequence by directing the first source of nuclear radiation to emit a first burst of radiation, then directing the second source of nuclear radiation to emit a second burst of radiation after a first time window has elapsed since a commencement of the first burst of radiation, and further wherein the burst sequencer is configured to repeat the burst sequence after a second time window has elapsed since a commencement of the second burst of radiation.

11. The system of claim 10, wherein the burst sequencer is further configured to initiate a rest cycle after a desired number of burst sequences in which the first pulsed source and the second pulsed source are induced to omit emitting radiation for a preset rest period

12. The system of claim 10, wherein the burst sequencer is further configured to coordinate measurements made by the one or more radiation sensors such that radiation detected by the one or more radiation sensors during the first time window can be attributed to the first source of nuclear radiation, and radiation detected by the one or more radiation sensors during the second time window can be attributed to the second source of nuclear radiation.

13. A method of implementing a burst sequence, the method comprising:
directing a first radiation source to emit a first burst of nuclear radiation;
instigating a first time window;
associating radiation detected by one or more sensors during the first time window with the first radiation source;
directing a second radiation source to emit a second burst of nuclear radiation after the first time window has elapsed;
instigating a second time window; and
associating radiation detected by the one or more sensors during the second time window with the second radiation source.

14. The method of claim 13, further comprising:
initiating a rest cycle when desired by inducing the first radiation source and the second radiation source to omit emitting nuclear radiation.

15. The method of claim 14, further comprising:
directing one or more sensors to measure ambient radiation during the rest cycle;
utilizing the measured ambient radiation to discern an extant background radiation;
using the extant background radiation to increase an accuracy of radiation levels detected at the one or more sensors during the first time window and the second time window.

16. The method of claim 13, further comprising:
altering the first time window to increase a likelihood that radiation detected from the first burst by the one or more sensors is correctly attributed to the first radiation source.

17. A computer-readable tangible medium with instructions stored thereon that, when executed, direct a processor to perform acts comprising:
implementing a burst sequence by performing acts including:
directing a first radiation source to emit a first burst of nuclear radiation;
instigating at some point in time after a commencement of the first burst a commencement and conclusion of a first time window;
attributing radiation detected by one or more sensors during the first time window to the first radiation source;
directing a second radiation source to emit a second burst of nuclear radiation at some point in time after the conclusion of the first time window;
instigating at some point in time after a commencement of the second burst a commencement and conclusion of a second time window; and
attributing radiation detected by one or more sensors during the second time window to the second radiation source.

18. The computer-readable medium of claim 17, further including instructions to direct a processor to perform acts comprising:
initiating a repeat of the burst sequence at some point in time after the conclusion of the second time window.

19. The computer-readable medium of claim 17, further including instructions to direct a processor to perform acts comprising:
initiating a rest cycle after a desired number of burst sequences, the rest cycle lasting for a preset rest period.

20. The computer-readable medium of claim 19, further including instructions to direct a processor to perform acts comprising:
directing the one or more sensors to measure ambient radiation extant during the rest period;
utilizing the measured ambient radiation to discern an extant background radiation;
subtracting the extant background radiation from radiation detected by the one or more sensors in selected future burst sequences to arrive at an improved reading of radiation attributed to the first and second radiation sources.

21. The computer-readable medium of claim 19, further including instructions to direct a processor to perform acts comprising:
initiating a burst sequence once the rest period elapses.

22. The computer-readable medium of claim 17, further including instructions to direct a processor to perform acts comprising:
adjusting the first time window to increase a likelihood that radiation from the first burst detected by the one or more sensors is correctly attributed to the first radiation source.

23. The computer-readable medium of claim 17, further including instructions to direct a processor to perform acts comprising:
adjusting the second time window to increase a likelihood that radiation from the second burst detected by the one or more sensors is correctly attributed to the second radiation source.
